(19) United States
(12) Patent Application Publication
(10) Pub. No.: US 2019/0264465 A1
(43) Pub. Date: Aug. 29, 2019

(54) Electronic Deadbolt and Key Fob

(71) Applicant: Agnissn Adje, Bronx, NY (US)

(72) Inventor: Agnissn Adje, Bronx, NY (US)

(21) Appl. No.: 15/904,195

(22) Filed: Feb. 23, 2018

(51) Int. Cl. E05B 47/00; E05B 17/10; E05B 15/16; E05B 15/10; G07C 9/00

(52) U.S. Cl. CPC E05B 47/0001; E05B 17/10; E05B 15/1621; E05B 15/10; G07C 2009/00984; E05B 2047/0058; E05B 2047/0084; E05B 2047/0097; G07C 2009/00642; G07C 9/00714

(57) ABSTRACT

An electronic lock system specially designed for a home's front and back doors and containing a built-in receiving unit that is operated by a corresponding remote control transmitter.

### CLAIM OF PRIORITY

This patent application claims priority under 35 USC 119 (e) (1) from U.S. Provisional Patent Application Ser. No. 62/462,824 filed Feb. 23, 2017, of common inventorship herewith entitled, “Digi Lock,” which is incorporated herein by reference as though the same were set forth in its entirety.

### FIELD OF THE INVENTION

The present invention pertains to the field of digital lock systems, and more specifically to the field of digital lock systems specially designed for a home's front and back doors and containing a built-in receiving unit that is operated by a corresponding remote control transmitter.

### BACKGROUND OF THE INVENTION

Ever since its first appearance nearly eighty years ago, wireless remote technology has continuously evolved to make many aspects of everyday life more convenient e first machines to be operated by remote control were used mainly for military purposes. Radio-controlled motorboats, developed by the German navy, were used to ram enemy ships in World War I. Twenty years later, radio controlled bombs and other remote control weapons were used in World War II. Once the wars were over, United States scientists began experimenting to find nonmilitary uses for the remote control. In the late 1940's automatic garage door openers were invented, and in the 1950's the first TV remote controls were used. Today, remote keyless entry is a standard option on most new automobiles. Whether changing television channels from the comforts of the couch, adjusting the volume on the stereo while lying in bed, or unlocking the car door while ten feet away from the vehicle, consumers have fully embraced, and have come to depend, on the remote control.

The prior art has put forth several designs for digital lock systems. Among these are:

U.S. Pat. No. 5,678,436 to Curtis Earl Alexander describes a remote control door lock system connectable to a door about a deadbolt lock for remotely unlocking or locking the deadbolt is provided. The remote control door lock system comprises: a housing mountable to a door about a deadbolt lock; an electric motor having a motor shaft mounted within the housing, the motor shaft being directed toward the deadbolt lock; a key frame rigidly connected to the motor shaft, the key frame is adapted for holding a deadbolt key, the key is operationally insertable into the deadbolt lock; a receiver switch mechanism in connection with the electric motor for selectively operating the electric motor; a power source in connection with the switching mechanism and t he electric motor; and a remote transmitter adapted to send a signal to the receiver switch for selectively operating the motor in a direction turning the key frame and the key in a direction to operate tie deadbolt lock.

U.S. Pat. No. 6,005,306 to Andrew M. Pickard describes a wireless remote control lock system for residential and commercial building pedestrian doors includes an electrically powered striker plate assembly having a striker plate member moveable between positions for engagement and disengagement with a door latch member. The striker assembly is adapted to be connected to a control unit which supplies low voltage DC power to the striker assembly and includes a radio frequency range signal receiver and a circuit responsive to receiving signals from an operator controlled radio transmitter to effect indefinite or momentary operation of the striker assembly to unlock a door. The control unit circuit includes a first self-latching relay, a selector switch and a second relay for selecting an operating mode of the system wherein the door may be unlatched momentarily (for about 3.5 seconds, for example) or indefinitely until a second signal is transmitted by the transmitter to the receiver.

U.S. Pat. No. 6,035,676 to Chad W. Hudspeth describes a system for remote operation of a deadbolt lock locks or unlocks a deadbolt associated with a door with a remotely-operated actuator that is operationally coupled to deadbolt. The system can convert an existing manually operated deadbolt into a remotely operated deadbolt by replacing an existing turnpiece associated with the manually operated deadbolt with a remotely operated actuator. Alternatively, the system can lock door of building by mounting system on or in either door or building. System can cooperate with other security systems in the building, including a siren or a window sensor.

None of these prior art references describe the present invention.

### SUMMARY OF THE INVENTION

It is an object of the present invention to provide an electronic lock system specially designed for a home's front and back doors and containing a built-in receiving unit that is operated by a corresponding remote control transmitter.

### BRIEF DESCRIPTION OF THE DRAWINGS

FIG. 1a is a front perspective view illustrating an electronic dead bolt for a digital lock system, constructed in accordance with the present invention.

FIG. 1b is a back perspective view illustrating an electronic dead bolt for a digital lock system, constructed in accordance with the present invention.

FIG. 2a is a front perspective view illustrating using the key fob for of the digital lock system for opening a door, constructed in accordance with the present invention.

FIG. 2b is a back perspective view illustrating using the key fob for of the digital lock system for opening a door, constructed in accordance with the present invention.

### DETAILED DESCRIPTION OF THE INVENTION

Please refer to the drawings.

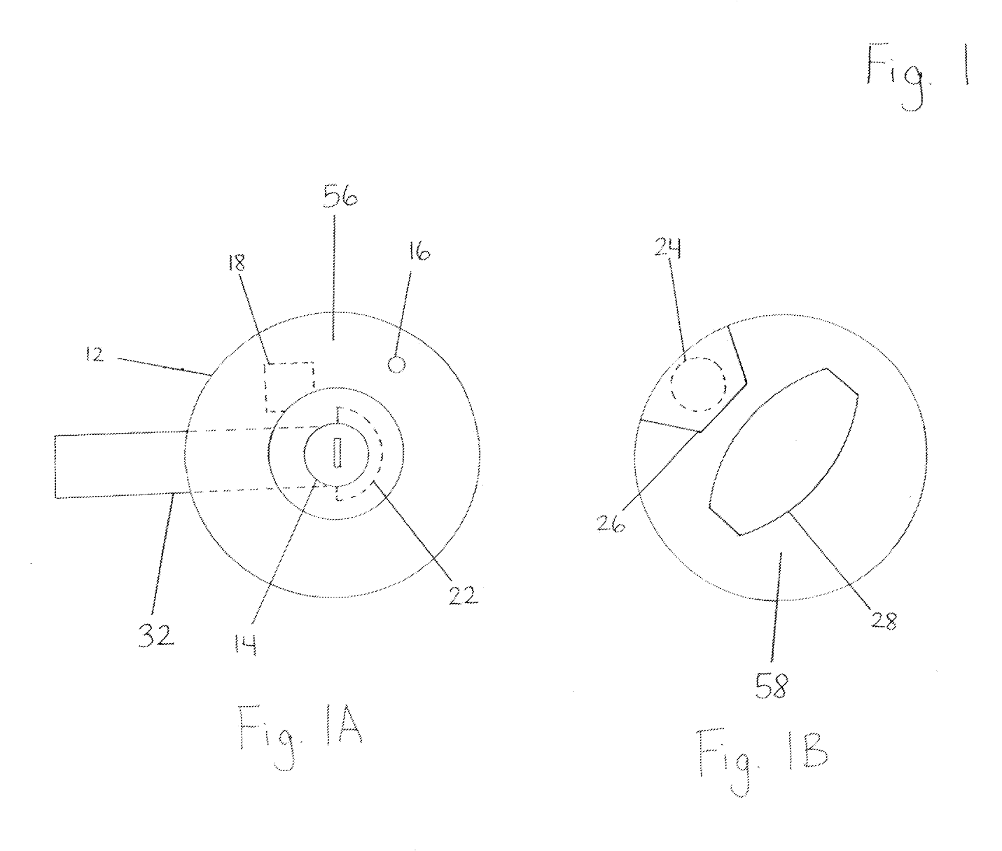

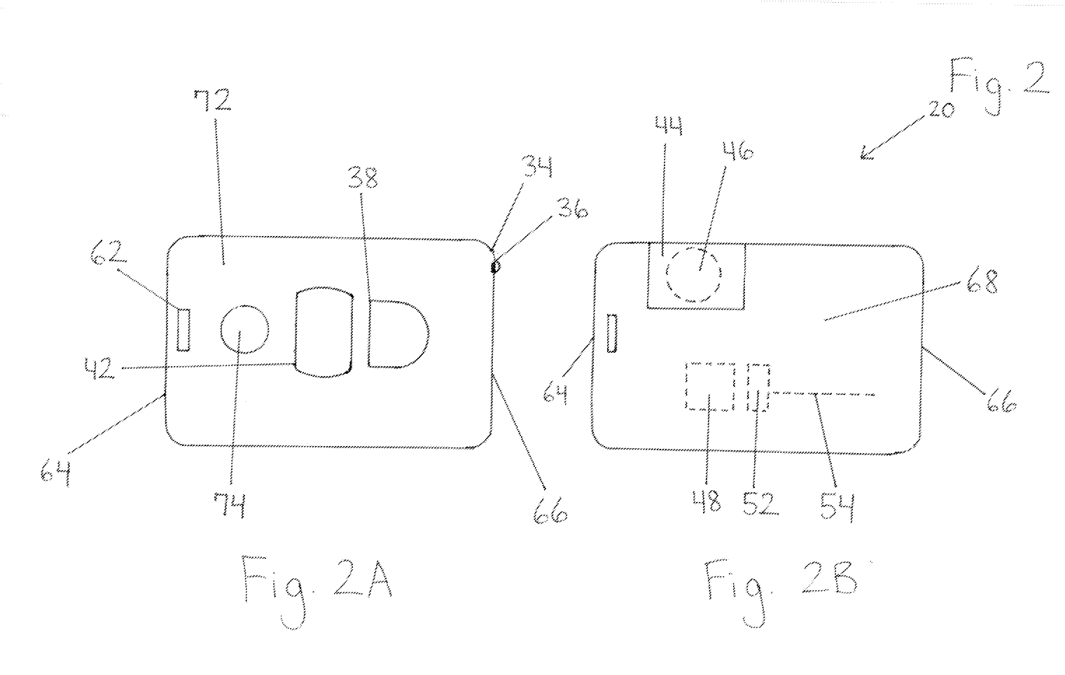

As described in FIGS. 1 and 2, the present invention, Electronic Deadbolt and Key Fob, comprises a means of enhancing safety and convenience by remotely locking and unlocking a dedicated, battery-powered deadbolt.

The present invention is an Electronic Deadbolt and Key Fob specially designed for a home's front and back doors and containing a built-in receiving unit that is operated by a corresponding remote control transmitter. Sized to fit the standard cutouts on most doors, the deadbolt can be made of one-inch hardened steel, for example, and feature a combination of wood and plastic housing. A receiver circuit, along with a tuned frequency, is encased within the lockset's sturdy housing. In addition, a flashing, red light emitting diode (LED) can be incorporated into the design of the lockset to offer an indicator that the lock has been activated or disengaged. The key fob serves as the transmitter for the remote control and can be any suitable geometric configuration, such as rectangular in shape and resemble the standard keychain variety remote control devices common to automobiles, measuring approximately two and one half inches (2 ½″) in length and one and one quarter inches (1 ¼″) in width.

Located on the front panel of the key fob unit, two (2) buttons positioned side by side activate the system's lock/unlock capabilities. With a range of three (3) meters, the interior of the remote control components are comprised of a frequency generator. amplifier, internal antenna, and the required electrical/electronic components and circuitry, all encased within the key fob's durable plastic housing. For added convenience, the remote control key fob boasts a brilliant light emitting diode (LED) to serve as a handy flashlight. Both the receiver and transmitter are powered by a coin-cell type battery, and feature a red LED to indicate a low battery state.

Use of the Electronic Deadbolt and Key Fob is very simple and straightforward. First, fallowing package instructions, the user replaces existing door hardware with this product's deadbolt lock/receiver system. Once the lockset has been installed, the Electronic Deadbolt and Key Fob is ready for use. On the way out, the user presses the “Lock” button on the remote control to lock the door, ensuring no unwanted visitors enter while away. The companion receiving unit, or the lock itself, is tuned to the specific frequency generated by the transmitter unit. Upon reception of the signal generated by the transmitter, the circuitry in the receiver generates an ‘enable’ signal to a logic device (an ‘AND’ integrated circuit chip or comparable) which applies a voltage level to the deadbolt, causing the lock to fully engage. Upon returning home, the user unbolts the door from the driveway by pressing the “Unlock” button. In a manner similar to that described above, the lock disengages, granting quick and easy ingress to the home.

In a primary embodiment, shown in FIGS. 1 and 2, Electronic Deadbolt and Key Fob consists of a battery-powered deadbolt, indicated at 10, and a key fob, indicated at 20.

As shown in FIG. 1, battery-powered deadbolt 10 consists of a lock housing 12, the components of which are constructed from a suitable material such as galvanized steel, wood, plastic, or a combination thereof. Lock housing 12 further consists of outer face 56 and inner face 58. Lock housing 12 is installed within a door in the same manner as a typical deadbolt, wherein the door has an interior side and an exterior side, such that outer face 56 is accessible on the outside, or exterior side of the door, and inner face 58 is accessible on the inside, or interior side of the door. Centered in outer face 56 of lock housing 12 is a standard key cylinder 14, allowing for typical deadbolt operation with a key. Above and to the right of key cylinder 14 is low battery light 16. Within lock housing 12, above and to the left of key cylinder 14 is receiver 18. Centered within lock housing 12 is electronic lock cylinder 22. Within lock housing 12 is dead bolt 32, constructed from a suitable material such as one-inch hardened steel, and situated so as to interface appropriately with electronic lock cylinder 22 and standard key cylinder 14. Centered on inner face 58 is manual thumb turn 28. Above and to the left of manual thumb turn 28 is battery compartment 26. Within battery compartment 26 is battery 24, which is a coin-cell type battery, and which supplies power to battery-powered deadbolt 10.

As shown in FIG. 2, indicated at 20, is battery-powered key fob. Battery powered key fob 20 consists of housing 34, constructed of a suitable, lightweight material such as injection-molded plastic. Housing 34 consists of a top 72 and a bottom 68. Housing 34 further consists of a front end 66 and a back end 64. On front end 66 is light emitting diode 36. On back end 64 is key ring attachment 62. Centered on top 72 is unlock button 42. Proximal to unlock button 42 and between unlock button 42 and front end 66 is lock button 38. Proximal to unlock button 42 and between unlock button 42 and back end 64 is light button 74. Along one side of bottom 68 is located battery compartment 44. Within battery compartment 44 is located battery 46, which is a coin-cell type battery, and which supplies power to battery-powered key fob 20. Within housing 34 is frequency generator 48. Proximal to frequency generator 48 is amplifier 52. Proximal to amplifier 52 is antenna 54.

In the primary embodiment, when lock button 38 of battery-powered key fob 20 is depressed, frequency generator 48 generates a unique frequency. This unique frequency is amplified by amplifier 52. The amplified frequency is transmitted by antenna 54. Receiver 18 of battery-powered deadbolt 10 receives this frequency, and triggers electronic lock cylinder 22 to extend or retract deadbolt 32 by any suitable means, such as magnetic or spring release. Additionally, battery-powered deadbolt 10 can be operated like a typical deadbolt, wherein the appropriate key is inserted into key cylinder 14 to engage a standard tumbler, cam bar, and shaft array to extend and retract dead bolt 32 to lock or unlock the door. Similarly, manual thumb turn 28 can be turned in a clockwise or counterclockwise direction to extend or retract deadbolt 32. When battery 24 is depleted to a certain percentage of its charge, low battery light 16 is illuminated to alert the user to this fact. Additionally, in low light conditions, light button 74 of battery-powered key fob 20 may be depressed to illuminate light emitting diode 36 and supply light for enhanced security.

Electronic Deadbolt and Key Fob offers consumers the ultimate combination of convenience and security for their homes. By providing an automatic, keyless means of locking and unlocking their front and back doors, Electronic Deadbolt and Key Fob fosters peace of mind in homeowners while allowing them to access and secure their homes with the simple press of a button, making it ideal for occasions when it is impractical or unsafe to fruitlessly fumble for a set of keys—whether in the dead of night, in inclement weather, or when at risk of mugging or attack.

There are several significant benefits and advantages associated with the Electronic Deadbolt and Key Fob. Foremost, the Electronic Deadbolt and Key Fob provides users with an automatic, keyless means of locking and unlocking their front and back doors. Combining the security of a deadbolt with the convenience of a remote control, the Electronic Deadbolt and Key Fob fosters peace of mind in homeowners while allowing them to both access and secure their homes with the simple pressing of buttons. In this manner, this product is ideal for occasions when it is not practical, or safe, to fruitlessly fumble for a set of keys. Whether coming home in a blinding snowstorm, the pouring rain, the dead of night, or even loaded down with grocery bags, the Electronic Deadbolt and Key Fob provides an expedient means of entering the house with barely a pause. Since no wiring is needed, this handy product can be easily installed with standard household tools. While the Electronic Deadbolt and Key Fob was primarily conceived with households in mind, businesses also appreciate the versatility of this product. Made of durable, high quality materials and components, the Electronic Deadbolt and Key Fob will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A battery-powered deadbolt and key fob consists of a lock housing and key fob wherein the lock housing houses an electronic key cylinder; wherein the lock housing further consists of an outer face and inner face, wherein the lock housing is capable of being installed within a door wherein the door has an exterior side and an interior side, such that outer face is of the lock housing is accessible on the exterior side of the door, and inner face of the lock housing is accessible on the interior side of the door, and further wherein an electronic key cylinder is centered in the outer face of lock housing, allowing for typical deadbolt operation with a key, further wherein a low battery light is positioned above and to the right of key cylinder, and further wherein a receiver is positioned on the lock housing above and to the left of electronic key cylinder, further wherein the electronic key cylinder is centered within lock housing; and further wherein the lock housing comprises a battery compartment and a battery; and further wherein:
the key fob is a battery powered key fob consisting of housing wherein housing consists of a top and a bottom, and housing further consists of a front end and a back end, wherein a light emitting diode is positioned on the front end and a key ring attachment is positioned on the back, further wherein an unlock button is positioned on the center of the top, and a lock button is positioned on the top proximal to the unlock button positioned between the unlock button and the front end, and further wherein a light button is positioned between unlock button and back end, wherein the light button activates a light contained in the key fob, and wherein the key fob contains a frequency generator, amplifier and antenna.

2. The battery-powered deadbolt and key fob of claim 1, wherein the housing is constructed of a suitable, lightweight material including injection-molded plastic.

3. The battery-powered deadbolt and key fob of claim 1, further wherein a battery compartment is located on one side of the housing of the key fob, wherein the battery compartment houses a coin-cell type battery, which supplies power to the key fob.

4. The battery-powered deadbolt and key fob of claim 1, wherein the deadbolt is constructed of hardened steel.

5. The battery-powered deadbolt and key fob of claim 1, further wherein a manual thumb turn is centered on the inner face of the lock housing.

6. The battery-powered deadbolt and key fob of claim 1, further wherein the key housing further comprises a battery compartment, capable of housing a coin-cell type battery, which supplies power to battery-powered deadbolt.

8. The battery-powered deadbolt and key fob of claim 1, wherein the lock housing is constructed from a suitable material including galvanized steel, wood plastic, or a combination thereof.

9. The battery-powered deadbolt and key fob of claim 1, wherein depression of the lock button on the key fob causes the frequency generator to generate a unique frequency, which unique frequency is amplified by the amplifier and the amplified frequency is transmitted by the antenna, and the amplified frequency is received by the receiver of battery-powered deadbolt, and receipt of the amplified frequency triggers electronic lock cylinder to extend or retract the deadbolt by any suitable means, such as magnetic or spring release.

10. The battery-powered deadbolt and key fob of claim 1, wherein the low battery light is illuminated when the battery in the battery the lock housing is depleted to a certain percentage of its charge

11. The battery-powered deadbolt and key fob of claim 1, further comprising a light button which activates a light when depressed to supply light for enhanced security.
